(19) United States
(12) Patent Application Publication
(10) Pub. No.: US 2026/0005460 A1
(43) Pub. Date: Jan. 1, 2026

(54) REMOVABLE CONNECTOR WITH FLIP COVER

(71) Applicant: Shenzhen Alex Connector Co Ltd, Shenzhen (CN)

(72) Inventors: Xiling He, Shenzhen (CN); Huilin Wu, Shenzhen (CN); Jijian Wei, Shenzhen (CN); Haiqiu Lu, Shenzhen (CN); Xiaoan Wang, Shenzhen (CN); Xiaobin Wang, Shenzhen (CN); Shiwei Zhan, Shenzhen (CN)

(21) Appl. No.: 18/807,210

(22) Filed: Aug. 16, 2024

(30) Foreign Application Priority Data
Jun. 26, 2024 (CN) 202421476415.1

(51) Int. Cl. H01R 13/453; H01R 12/70; H01R 12/71; H01R 13/629; H01R 13/639; H01R 13/652

(52) U.S. Cl. CPC H01R 13/453; H01R 12/7023; H01R 12/716; H01R 13/629; H01R 13/639; H01R 13/652

(57) ABSTRACT

The present disclosure discloses a removable connector with a flip cover, including: a female socket and a plug. The female socket is fixedly mounted on a printed circuit board (PCB); a connecting column is arranged on an outer side of the female socket; a bracket is arranged on an outer side of the plug; the bracket includes a connecting plate and a flip cover; the connecting plate is perpendicular to the flip cover; the middle of the connecting plate is rotatably connected to the plug through a rotating member; an arc-shaped locking slot is formed in the connecting plate in a rotating direction of the rotating member; and the connecting column can be clamped into the locking slot and slide along the locking slot.

### TECHNICAL FIELD

The present disclosure relates to the technical field of connectors, and in particular, to a removable connector with a flip cover.

### BACKGROUND

A connector, or referred to as a plug connector, or referred to as a plug and socket in China, is a device that connects two active devices and builds a bridge for communication. A male end and female end of the connector can transmit information or current via contact.

The existing connectors are usually plugged into a female socket on a printed circuit board (PCB), and the connectors are usually fixed on the female socket through a buckle structure. The existing snap-in structure usually includes a clamping hole and a clamping block. When the connector is plugged into the female socket, the clamping block may be clamped into the clamping hole, thereby achieving an effect of fixing the connector. Through this connection method, to remove the connector, the clamping block needs to be withdrawn from the clamping hole. As multiple connectors usually need to be mounted on the PCB, it is difficult to withdraw the clamping block from the clamping hole in the conventional way. As a result, it is inconvenient to remove the connector.

### SUMMARY

The present disclosure mainly aims to provide a removable connector with a flip cover, and is directed to solve the problem that it is inconvenient to remove a connector.

To achieve the above objectives, the present disclosure provides a removable connector with a flip cover, including: a female socket and a plug. The female socket is fixedly mounted on a printed circuit board (PCB); a connecting column is arranged on an outer side of the female socket; a bracket is arranged on an outer side of the plug; the bracket includes a connecting plate and a flip cover; the connecting plate is perpendicular to the flip cover the middle of the connecting plate is rotatably connected to the plug through a rotating member; an arc-shaped locking slot is formed in the connecting plate in a rotating direction of the rotating member; and the connecting column is clamped into the locking slot and slides along the locking slot.

Optionally, an outer protrusion is arranged between one end of the locking slot and a side edge of the corresponding connecting plate; and the outer protrusion is configured to allow the connecting column to enter the locking slot.

Optionally, one end of the locking slot close to the outer protrusion is an unlocked end; one end of the locking slot away from the outer protrusion is a locked end; and a distance from the locked end to a center of the rotating member is shorter than a distance from the unlocked end to the center of the rotating member.

Optionally, a spring contact piece is arranged at a lower end of the plug; and the spring contact piece is configured to be in touch-control connection with a touch-control sheet on the PCB.

Optionally, on the bracket, a circular clamping position is provided at a position between the flip cover and the connecting plate; a hemispherical convex hull is arranged at a position, corresponding to the clamping position, on a side surface of the plug after the bracket is rotated to be locked; and the convex hull is clamped into the corresponding clamping position.

Optionally, two guide sheets are symmetrically arranged at an upper end of the female socket; guide slots corresponding to the two guide sheets are separately provided at a lower end of the plug; and the guide sheets are plugged into the corresponding guide slots.

Optionally, a curled edge is arranged at one end of the flip cover away from the connecting plate; the curled edge is outwards curled into a hook shape; and the flip cover is pulled through the curled edge.

Optionally, the female socket is a structure made of a metal material, and is configured to be connected and conducted with a ground wire.

Optionally, the bracket is a structure made of a metal material.

Optionally, the bracket is a structure integrally molded by stamping.

According to the technical solutions of the present disclosure, the connecting column is arranged on the female socket; the bracket rotatably connected to the plug is arranged on the outer side of the plug; and the arc-shaped locking slot is arranged on the bracket. Thus, when the plug is plugged on the female socket, the connecting column may enter the locking slot; and the bracket is rotated to move a locking portion of the locking slot to the connecting column. In this process, the distance between the connecting column and the bracket will be slowly shortened, which can lock the plug. This design can stably connect the plug on the PCB. Meanwhile, the plug can be unlocked and locked by flipping the bracket, thereby facilitating the mounting and removal of the plug.

### BRIEF DESCRIPTION OF THE DRAWINGS

To describe the technical solutions in the embodiments of the present disclosure or in the prior art more clearly, the following briefly introduces the accompanying drawings for describing the embodiments or the related art. Apparently, the accompanying drawings in the following description show merely some embodiments of the present disclosure, and a person of ordinary skill in the art may still derive other drawings according to structures shown in these accompanying drawings without creative efforts.

FIG. 1 is a schematic structural diagram of a removable connector with a flip cover according to the present disclosure;

FIG. 2 is a schematic diagram of an exploded structure of a removable connector with a flip cover.

FIG. 3 is a schematic structural diagram of a female socket of a removable connector with a flip cover;

FIG. 4 is a schematic structural diagram of a plug of a removable connector with a flip cover;

FIG. 5 is a partially structural enlarged diagram of part A in FIG. 1 of the removable connector with the flip cover;

FIG. 6 is a partially structural enlarged diagram of part B in FIG. 2 of the removable connector with the flip cover; and

FIG. 7 is a schematic diagram of a locked state of a removable connector with a flip cover.

The implementations, functional features, and advantages of the present disclosure will be further explained in conjunction with the embodiments and with reference to the accompanying drawings.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

It should be noted that if there are directional indications (such as up, down, left, right, front, back . . . ) involved in the embodiments of the present disclosure, the directional indications are only used to explain the relative positional relationship, motion states, and the like between various components in specific postures (as shown in the accompanying drawings). If the specific postures change, the directional indications also change correspondingly.

In addition, if there are descriptions related to “first”, “second”, and the like in the embodiments of the present disclosure, the descriptions of “first”, “second”, and the like are only used for descriptive purposes and cannot be understood as indicating or implying their relative importance or implying the quantities of indicated technical features. From this, features defined as “first” and “second” may explicitly or implicitly include at least one feature. In addition, if “and/or” herein means including three parallel schemes, “A and/or B” is taken as an example, which includes scheme A, scheme B, or a scheme that is satisfied by both A and B. In addition, the technical solutions between the various embodiments can be combined with each other, but need to be implemented by those of ordinary skill in the art. When there is a conflict in a combination of technical solutions or the combination cannot be achieved, it should be considered that the combination of the technical solutions does not exist and does not fall within the protection scope of the present disclosure.

The existing connectors are usually plugged into a female socket on a printed circuit board (PCB), and the connectors are usually fixed on the female socket through a buckle structure. The existing snap-in structure usually includes a clamping hole and a clamping block. When the connector is plugged into the female socket, the clamping block may be clamped into the clamping hole, thereby achieving an effect of fixing the connector. Through this connection method, to remove the connector, the clamping block needs to be withdrawn from the clamping hole. As multiple connectors usually need to be mounted on the PCB, it is difficult to withdraw the clamping block from the clamping hole in the conventional way. As a result, it is inconvenient to remove the connector.

In view of this, the present disclosure provides a removable connector with a flip cover, including: a female socket 1 and a plug 2. The female socket 1 is fixedly mounted on a PCB 3; a connecting column 120 is arranged on an outer side of the female socket 1; a bracket 4 is arranged on an outer side of the plug 2; the bracket 4 includes a connecting plate 410 and a flip cover 420; the connecting plate 410 is perpendicular to the flip cover 420; the middle of the connecting plate 410 is rotatably connected to the plug 2 through a rotating member 5; an arc-shaped locking slot 412 is formed in the connecting plate 410 in a rotating direction of the rotating member 5; and the connecting column 120 can be clamped into the locking slot 412 and slide along the locking slot 412.

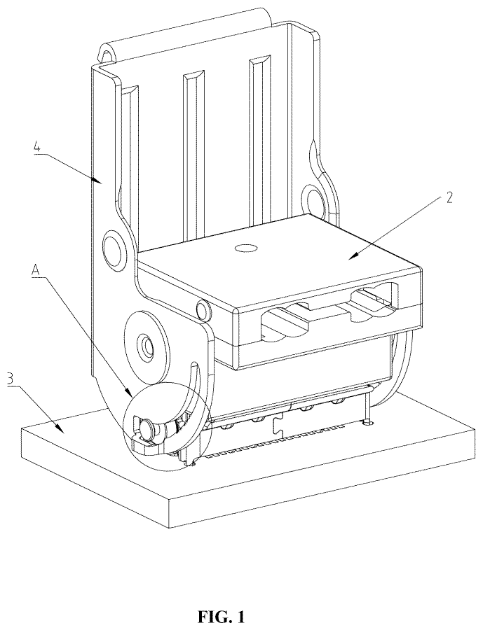

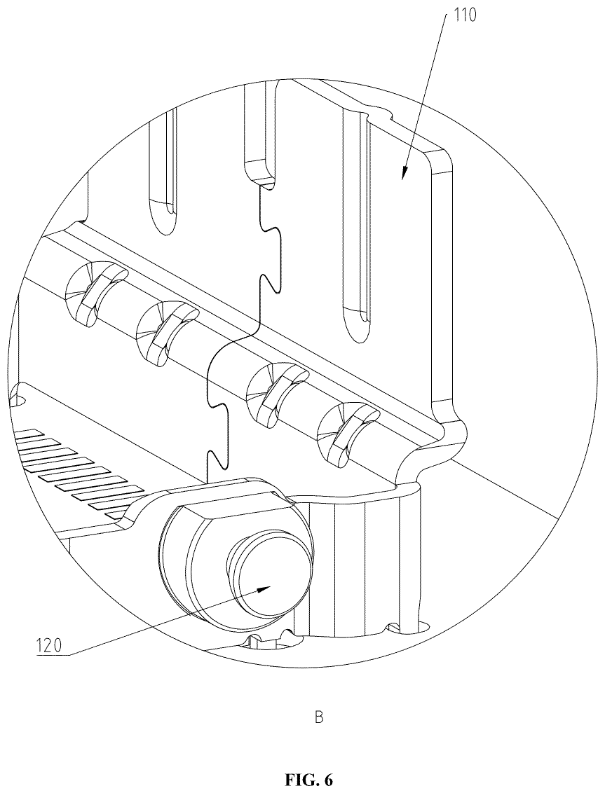

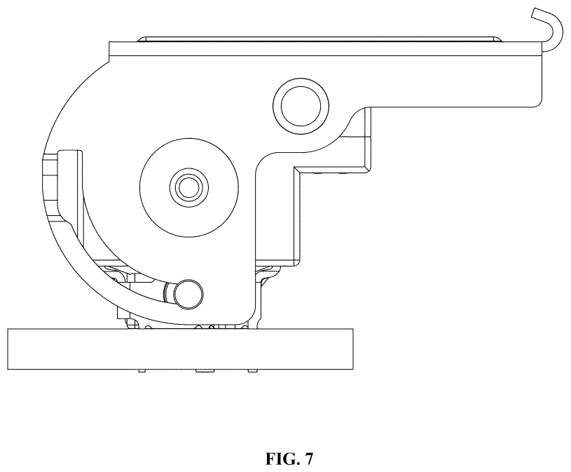

In the embodiments of the present disclosure, referring to FIG. 1 to FIG. 7, the removable connector with the flip cover includes the female socket 1 and the plug 2. The female socket 1 is fixedly mounted on the PCB 3; the bracket 4 is arranged on the outer side of the plug 2. The bracket 4 is a metal sheet and is integrally formed by stamping. The bracket 4 is rotatably mounted on the plug 2 through two rotating members 5, so that the bracket 4 can rotate on the outer side of the plug 2 through the rotating members 5.

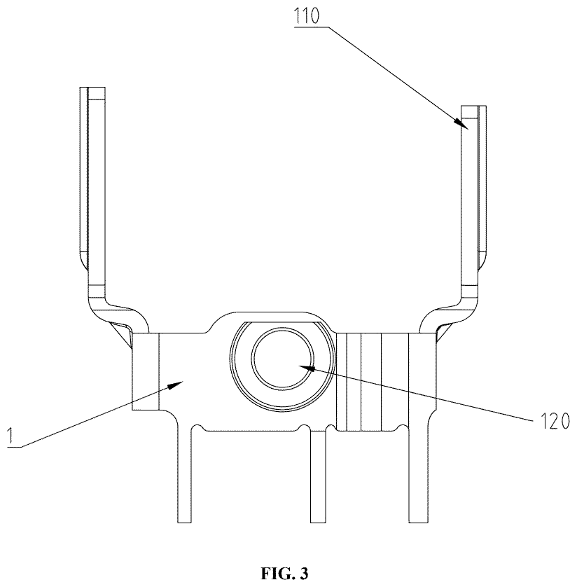

Referring to FIG. 3, the female socket 1 is made of a metal material, which is convenient for connection and conduction with a ground wire. A lower end of the female socket 1 is inserted into the PCB 3 and is fixedly connected to the PCB. Two guide sheets 110 are symmetrically arranged at an upper end of the female socket 1 to guide the insertion of the plug 2 and provide positioning for the plug 2. Two horizontal connecting columns 120 are coaxially arranged in the front and back of the middle of an outer side of the female socket 1. The two connecting columns 120 are fixedly connected to the female socket 1. The connecting columns 120 are cylindrical for connection with the bracket 4.

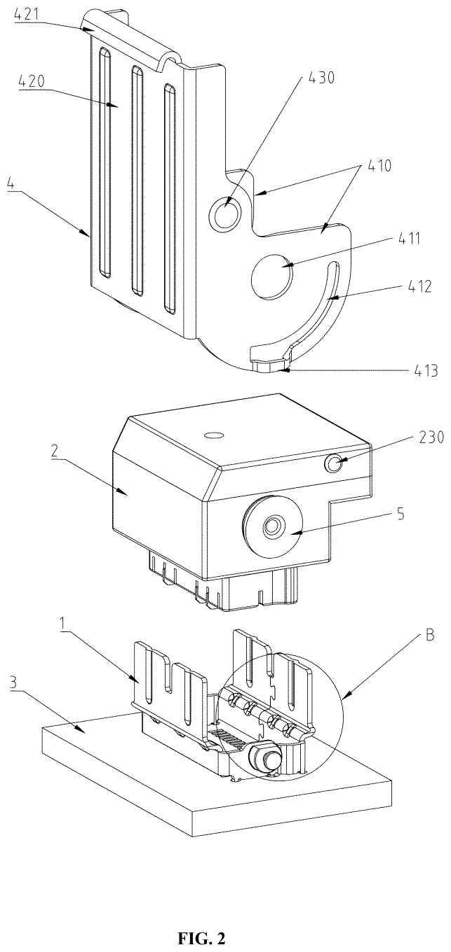

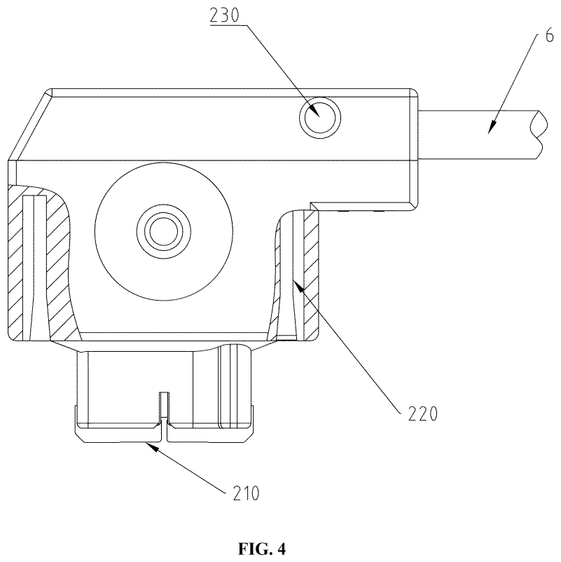

Referring to FIG. 2 and FIG. 4, a position, close to an upper end, of one side of the plug 2 is connected with a wire 6. A spring contact piece 210 is arranged at a lower end of the plug 2 and is configured to be in touch-control connection with a touch-control sheet on the PCB 3. The spring contact piece 210 is elastic. Guide slots 220 are separately formed in the lower end of the plug 2 on two sides of the spring contact piece 210. The positions of the guide slots 220 are consistent with the positions of the guide sheets 110, so that the guide sheets 110 can be inserted into the corresponding guide slots 220, so as to guide the plug.

Referring to FIG. 2, the bracket 4 includes two fan-shaped connecting plates 410 and a rectangular flip cover 420. The two connecting plates 410 are symmetrically distributed on two sides of one end of flip cover 420. The two connecting plates 410 are perpendicular to the flip cover 420. The two connecting plates 410 are located on the two sides of the plug 2 respectively, so that the bracket 4 wraps around the outer side of the plug 2. Connecting holes 411 are coaxially formed in the middles of the two connecting plates 410 for connection with the two rotating members 5, so that the bracket 4 can be rotated through the rotating members 5.

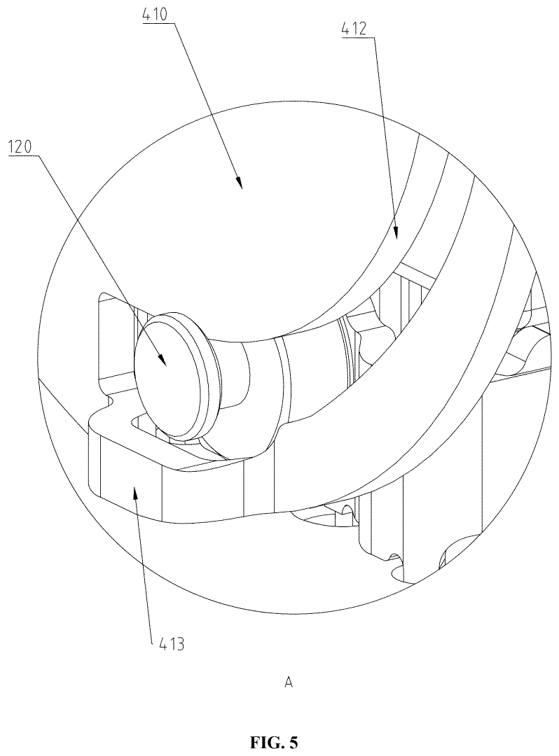

Referring to FIG. 2 and FIG. 5, arc-shaped locking slots 412 are formed in outer sides of the two connecting plates 410 corresponding to the connecting holes 411. An outer protrusion 413 that protrudes outwards is arranged between one end of each of the two locking slots 412 and a side edge of the corresponding connecting plate 410. The connecting columns 120 can enter the locking slots 412 through the outer protrusions 413. One end of each locking slot 412 close to the outer protrusion 413 is an unlocked end, and one end of the locking slot 412 away from the outer protrusion 413 is a locked end. A distance from the middle of the unlocked end of the locking slot 412 to the center of the connecting hole 411 is 5.9 mm, and a distance from the middle of the locked end of the locking slot 412 to the center of the connecting hole 411 is 5.4 mm, that is, the distance from the middle of the locked end of the locking slot 412 to the center of the connecting hole 411 is shorter than the distance from the unlocked end to the center of the connecting hole 411.

Referring to FIG. 1 and FIG. 5, when the plug 2 is plugged into the socket 2, the connecting columns 120 may enter the locking slots 412 through the outer protrusions 413. At this time, the flip cover 420 pushes the bracket 4 to rotate 900 around the rotating members 5, so that the connecting columns 120 slide along locking slots 412 to the locked ends to lock the plug 2 in the female socket 1, and the spring contact pieces 210 can stably press against the PCB 3.

Referring to FIG. 2, a curled edge 421 is arranged at one end of the flip cover 420 away from the connecting plates 410. The curled edge 421 is curled outwards into a hook shape. When a plurality of connectors are mounted on the PCB 3, a user cannot get a hand to a position below the flip cover. At this time, the flip cover 420 can be pulled through the curled edge 421.

Referring to FIG. 2, on the bracket 4, circular clamping positions 430 are provided at positions between the flip cover 420 and the two connecting plates 410; hemispherical convex hulls 230 are arranged at positions, corresponding to the two clamping positions, on a side surface of the plug 2 after the bracket 4 is rotated to be locked; after the bracket 4 is rotated to be locked, the convex hulls 230 may be clamped into the corresponding clamping positions on the bracket 4. At this time, resistance can be sensed on the bracket 4, which can achieve a locking prompt effect and prevent the bracket 4 from rotating on its own, so that the connection between the plug and the female socket 1 is more stable.

During use of this device, firstly, the plug 2 is plugged into the socket 1. At this time, the two guide sheets 110 may be inserted into the corresponding two guide slots 220, to guide the plug 2 to be plugged into a correct position on the PCB 3. Meanwhile, the two connecting columns 120 may enter the corresponding locking slots 412 through the corresponding outer protrusions 413. Then, the bracket 4 is pushed to rotate through the flip cover 420, so that the connecting columns 120 slide in the locking slots 412 until the connecting columns 120 move to locking portions of the locking slots 412. At this time, the convex shells 230 may be clamped into the corresponding clamping positions 430 on the bracket 4 to prevent the bracket 4 from rotating on its own, so that the connection between the plug and the female socket 1 is more stable.

According to the technical solutions of the present disclosure, the connecting columns are arranged on the female socket; the bracket rotatably connected to the plug is arranged on the outer side of the plug; and the arc-shaped locking slots are arranged on the bracket. Thus, when the plug is plugged on the female socket, the connecting columns may enter the locking slots; and the bracket is rotated to move the locking portions of the locking slots to the connecting columns. In this process, the distance between the connecting columns and the bracket will be slowly shortened, which can lock the plug. This design can stably connect the plug on the PCB. Meanwhile, the plug can be unlocked and locked by flipping the bracket, thereby facilitating the mounting and removal of the plug.

The above describes only optional embodiments of the present disclosure and does not limit the patent scope of the present disclosure. Any equivalent structural transformations made using the specification and accompanying drawings of the present disclosure within the inventive concept of the present disclosure, or directly or indirectly applied in other related technical fields, all fall within the scope of patent protection of the present disclosure.

What is claimed is:

1. A removable connector with a flip cover, comprising: a female socket and a plug, wherein the female socket is fixedly mounted on a printed circuit board (PCB); a connecting column is arranged on an outer side of the female socket; a bracket is arranged on an outer side of the plug; the bracket includes a connecting plate and a flip cover; the connecting plate is perpendicular to the flip cover; the middle of the connecting plate is rotatably connected to the plug through a rotating member; an arc-shaped locking slot is formed in the connecting plate in a rotating direction of the rotating member; and the connecting column is clamped into the locking slot and slides along the locking slot.

2. The removable connector with the flip cover according to claim 1, wherein an outer protrusion is arranged between one end of the locking slot and a side edge of the corresponding connecting plate; and the outer protrusion is configured to allow the connecting column to enter the locking slot.

3. The removable connector with the flip cover according to claim 2, wherein one end of the locking slot close to the outer protrusion is an unlocked end; one end of the locking slot away from the outer protrusion is a locked end; and a distance from the locked end to a center of the rotating member is shorter than a distance from the unlocked end to the center of the rotating member.

4. The removable connector with the flip cover according to claim 3, wherein a spring contact piece is arranged at a lower end of the plug; and the spring contact piece is configured to be in touch-control connection with a touch-control sheet on the PCB.

5. The flip cover removable connector according to claim 4, wherein on the bracket, a circular clamping position is provided at a position between the flip cover and the connecting plate; a hemispherical convex hull is arranged at a position, corresponding to the clamping position, on a side surface of the plug after the bracket is rotated to be locked; and the convex hull is clamped into the corresponding clamping position.

6. The removable connector with the flip cover according to claim 1, wherein two guide sheets are symmetrically arranged at an upper end of the female socket; guide slots corresponding to the two guide sheets are separately provided at a lower end of the plug; and the guide sheets are plugged into the corresponding guide slots.

7. The removable connector with the flip cover according to claim 1, wherein a curled edge is arranged at one end of the flip cover away from the connecting plate; the curled edge is outwards curled into a hook shape; and the flip cover is pulled through the curled edge.

8. The removable connector with the flip cover according to claim 1, wherein the female socket is a structure made of a metal material; and the female socket is configured to be connected and conducted with a ground wire.

9. The removable connector with the flip cover according to claim 1, wherein the bracket is a structure made of a metal material.

10. The removable connector with the flip cover according to claim 9, wherein the bracket is a structure integrally molded by stamping.
